(19) United States
(12) Patent Application Publication
(10) Pub. No.: US 2019/0075401 A1
(43) Pub. Date: Mar. 7, 2019

(54) MEMS DEVICES AND PROCESSES

(71) Applicant: Cirrus Logic International Semiconductor Ltd., Edinburgh (GB)

(72) Inventors: Richard Ian LAMING, Edinburgh (GB); Marek Sebastian PIECHOCINSKI, Edinburgh (GB)

(73) Assignee: Cirrus Logic International Semiconductor Ltd., Edinburgh (GB)

(21) Appl. No.: 16/110,158

(22) Filed: Aug. 23, 2018

(30) Foreign Application Priority Data
Sep. 5, 2017 (GB) 1714221.7
Feb. 8, 2018 (GB) 1802088.3

(51) Int. Cl. H04R 19/04; H04R 7/04

(52) U.S. Cl. CPC H04R 19/04; H04R 2201/003; H04R 7/04

(57) ABSTRACT

The application relates to a MEMS transducer comprising first and second conductive elements which defines a first capacitor of the transducer, and a third conductive element. The third conductive element is configured to be at a potential different to the potential of the second conductive element. The third conductive element is provided in a fringing field region of the first capacitor.

### TECHNICAL FIELD

This application relates to micro-electro-mechanical system (MEMS) devices and processes, and in particular to a MEMS device and process relating to a transducer, for example a capacitive microphone.

### BACKGROUND INFORMATION

MEMS devices are becoming increasingly popular. MEMS transducers, and especially MEMS capacitive microphones, are increasingly being used in portable electronic devices such as mobile telephone and portable computing devices.

Microphone devices formed using MEMS fabrication processes typically comprise one or more moveable membranes and a static backplate, with a respective electrode deposited on the membrane(s) and backplate, wherein one electrode is used for read-out/drive and the other is used for biasing. A substrate supports at least the membrane(s) and typically the backplate also. In the case of MEMS pressure sensors and microphones the read out is usually accomplished by measuring the capacitance between the membrane and backplate electrodes. In the case of transducers, the device is driven, i.e. biased, by a potential difference provided across the membrane and backplate electrodes.

FIGS. 1A and 1B show a schematic diagram and a perspective view, respectively, of a known capacitive MEMS microphone device 100. The capacitive microphone device 100 comprises a membrane layer 101 which forms a flexible membrane which is free to move in response to pressure differences generated by sound waves. A first electrode 102 is mechanically coupled to the flexible membrane, and together they form a first capacitive plate of the capacitive microphone device. A second electrode 103 is mechanically coupled to a generally rigid structural layer or back-plate 104, which together form a second capacitive plate of the capacitive microphone device. In the example shown in FIG. 1a the second electrode 103 is embedded within the back-plate structure 104.

The capacitive microphone is formed on a substrate 105, for example a silicon wafer which may have upper and lower oxide layers 106, 107 formed thereon. A cavity 108 in the substrate and in any overlying layers (hereinafter referred to as a substrate cavity) is provided below the membrane, and may be formed using a “back-etch” through the substrate 105. The substrate cavity 108 connects to a first cavity 109 located directly below the membrane. These cavities 108 and 109 may collectively provide an acoustic volume thus allowing movement of the membrane in response to an acoustic stimulus. Interposed between the first and second electrodes 102 and 103 is a second cavity 110. A plurality of holes, hereinafter referred to as bleed holes 111, connect the first cavity 109 and the second cavity 110.

A plurality of acoustic holes 112 are arranged in the back-plate 104 so as to allow free movement of air molecules through the back plate, such that the second cavity 110 forms part of an acoustic volume with a space on the other side of the back-plate. The membrane 101 is thus supported between two volumes, one volume comprising cavities 109 and substrate cavity 108 and another volume comprising cavity 110 and any space above the back-plate. These volumes are sized such that the membrane can move in response to the sound waves entering via one of these volumes. Typically the volume through which incident sound waves reach the membrane is termed the “front volume” with the other volume, which may be substantially sealed, being referred to as a “back volume”.

In some applications the backplate may be arranged in the front volume, so that incident sound reaches the membrane via the acoustic holes 112 in the backplate 104.

In such a case the substrate cavity 108 may be sized to provide at least a significant part of a suitable back-volume. In other applications, the microphone may be arranged so that sound may be received via the substrate cavity 108 in use, i.e. the substrate cavity forms part of an acoustic channel to the membrane and part of the front volume. In such applications the backplate 104 forms part of the back-volume which is typically enclosed by some other structure, such as a suitable package.

It should also be noted that whilst FIGS. 1A and 1B shows the backplate being supported on the opposite side of the membrane to the substrate, arrangements are known where the backplate is formed closest to the substrate with the membrane layer supported above it.

In use, in response to a sound wave corresponding to a pressure wave incident on the microphone, the membrane is deformed slightly from its equilibrium or quiescent position. The distance between the membrane electrode 102 and the backplate electrode 103 is correspondingly altered, giving rise to a change in capacitance between the two electrodes that is subsequently detected by electronic circuitry (not shown).

The membrane layer and thus the flexible membrane of a MEMS transducer generally comprises a thin layer of a dielectric material—such as a layer of crystalline or polycrystalline material. The membrane layer may, in practice, be formed by several layers of material which are deposited in successive steps. Thus, the flexible membrane 101 may, for example, be formed from silicon nitride Si₃N₄ or polysilicon. Crystalline and polycrystalline materials have high strength and low plastic deformation, both of which are highly desirable in the construction of a membrane. The membrane electrode 102 of a MEMS transducer is typically a thin layer of metal, e.g. aluminium, which is typically located in the centre of the flexible membrane 101, i.e. that part of the membrane which displaces the most. It will be appreciated by those skilled in the art that the membrane electrode may be formed by depositing a metal alloy such as aluminium-silicon for example. The membrane electrode may typically cover, for example, around 40% of area of the membrane, usually in the central region of the membrane.

Thus, known transducer membrane structures are composed of two layers of different material—typically a dielectric layer (e.g. SiN) and a conductive layer (e.g. AlSi).

Previously proposed transducer designs have been shown to demonstrate a degree of change—or drift—in sensitivity over time. There may be a number of reasons for this sensitivity drift. For example, the distance between the backplate and membrane electrodes may slowly alter over time due to e.g. repeated displacement of the membrane, or as a result of tensile stresses caused by the electrostatic deformation of the membrane structure. Consequently, the capacitance (Ct) at a time t may be different to the initial operating capacitance Co. This can lead to a DC offset in the measurement signal from such a transducer, as the capacitance at the quiescent position is not the same. Furthermore, for a.c. audio signals, the change in capacitance leads to a variation in the signal charge for a given acoustic stimulus.

Furthermore, as will be discussed in more detail, the presence of fringing fields at the edge of the capacitor may also contribute to sensitivity drift.

Although the level or degree of sensitivity drift is typically very small, more recent applications of MEMS microphones (e.g. the use of MEMS microphones within a beamforming array of microphones) may require new levels of performance stability. Thus, there is a desire to further improve the stability of the sensitivity of MEMS transducers.

The present disclosure invention relates to MEMS transducers and processes which seek to alleviate the occurrence of time-dependent sensitivity drift, by providing a transducer which a more stable sensitivity or performance over time.

### SUMMARY OF EMBODIMENTS

According to an example embodiment of a first aspect there is provided a MEMS transducer comprising first and second conductive elements, the second conductive element being provided in a plane which overlies a plane of the first conductive element, wherein a mutually overlapping region of the first and second conductive elements defines a first capacitor of the transducer,
the transducer further comprising a third conductive element, wherein the third conductive element is provided in a plane that overlies the plane of the first conductive element and wherein the third conductive element is configured to be at a potential different to the potential of the second conductive element.

According to an example embodiment of a second aspect there is provided a MEMS transducer comprising first and second conductive elements of a capacitor, the MEMS transducer further comprising a field modifier provided in a fringing field region of the capacitor, the field modifier located to form a parallel electric field between the second conductive element and the field modifier.

According to an example embodiment of a third aspect there is provided a MEMS transducer comprising:

a flexible membrane;

a rigid backplate;

a membrane electrode formed on an upper surface of the membrane;

a backplate electrode, formed on or within the backplate;

a third conductive element provided at a potential different to the potential of the membrane electrode and located so as to form a capacitor with the backplate electrode.

According to an example embodiment of a fourth aspect there is provided a MEMS transducer comprising:

a flexible membrane which is able to flex in response to a pressure differential across the membrane layer, wherein the flexible membrane is formed of a conductive material;

a rigid support structure which is electrically conductive, wherein a capacitor is defined between the membrane and the support structure,

a field modifier configured to form a capacitor with the rigid support structure.

The first and second conductive elements are arranged to define a first capacitor of the transducer. The third conductive element may be arranged with respect to the second conductive element to form a second capacitor of the transducer. The third conductive element may be provided in a fringing field region of the first capacitor.

A conductive path may be provided which directly connects the third conductive element to the first conductive element. The conductive path may comprise e.g. one or more conductive tracks and/or one or more conductive vias formed in a sidewall of the transducer. The conductive path may be connected to a charge pump of the transducer which is operable to apply a bias voltage to the first conductive elements. Alternatively, a circuit may be provided for providing a bias voltage to the third conductive element such that the third conductive element is at a voltage that is different to the voltage of the second conductive element, without providing a direct electrical connection between the first and third conductive elements.

The third conductive element may at least partially overlie the first conductive element when viewed in a direction normal to the third conductive element. The third conductive element may be provided in a region which, when projected onto the plane of the first electrode, overlies the edge of the first conductive element. The third conductive element may be provided in a region which, when projected onto the plane of the first electrode, is laterally outside the region of the first conductive element. The third conductive element may be configured to be at substantially the same potential as the potential of the first conductive element. Alternatively, in one or more examples, the third conductive element may be configured to be at a potential which differs by less than 15% of the potential of the first conductive element.

The third conductive element may comprise a plurality of sub-elements. Each of the element portions may be configured to be at substantially the same voltage. Alternatively, the third electrode may form a closed loop.

The third conductive element may be provided in a plane between the plane of the first conductive element and the plane of the second conductive element. The third conductive element may be provided in the same plane as the second conductive element. The third conductive element may be provided in a plane above the plane of the second conductive element.

According to one or more examples, the first conductive element may be supported by a flexible membrane of the MEMS transducer whilst the second electrode is supported by a fixed support structure (e.g. backplate) of the MEMS transducer. The third conductive element may also be supported by the fixed support structure. Thus, the second and third conductive elements may be conveniently supported on or embedded within a backplate structure of the transducer.

According to one or more other examples the first conductive element is provided on the fixed support structure of the MEMS transducer and the second conductive element is supported by the flexible membrane of the MEMS transducer. The third conductive element may also be supported by the flexible membrane.

According to the present embodiments the third conductive element is beneficially positioned so as to form a capacitor with the second conductive element.

Associated methods of fabricating a MEMS transducer are provided for each of the above aspects and examples described herein.

### BRIEF DESCRIPTION OF THE DRAWINGS

For a better understanding of the present invention and to show how the same may be carried into effect, reference will now be made, by way of example, the accompanying drawings in which:

FIGS. 1A and 1B illustrate known capacitive MEMS transducers in section and perspective views;

FIG. 2 illustrates electric field lines between first and second electrodes of a parallel plate capacitor;

FIGS. 3A to 3D each illustrate a partial, cross sectional view of a plurality of conductive elements according to examples of the present embodiments;

FIGS. 4A and 4B illustrate the effect of the third conductive element on the electric fields;

FIGS. 5A to 5C each illustrate a partial, cross sectional view of a plurality of conductive elements according to further examples of the present embodiments;

FIGS. 6A to 6D each show a plan view of a plurality of conductive elements according to further example embodiments;

FIGS. 7A and 7B illustrate first, second and third conductive elements of a MEMS transducer according to further example embodiments;

FIGS. 8A and 8B illustrate first, second and third conductive elements of a MEMS transducer according to further example embodiments;

FIG. 9 illustrates a plan view of first, second and third conductive elements of further example embodiment of a MEMS transducer;

FIG. 10 illustrates a MEMS transducer according to one example embodiment;

FIG. 11 illustrates a part of a second conductive element which comprises a plurality of hexagonal holes; and

FIGS. 12A and 12B illustrate further example embodiments.

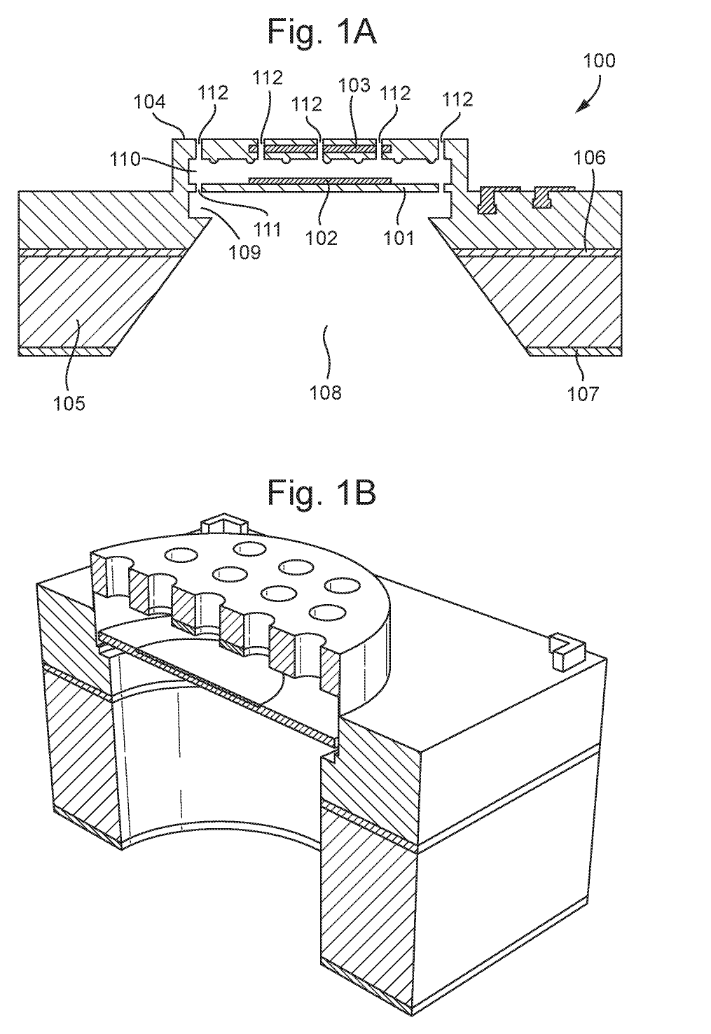

### DETAILED DESCRIPTION

It will be appreciated that the drawings may not be to scale and are for the purpose of illustration only.

Examples described herein relate to MEMS capacitive transducers comprising a plurality of conductive elements. In the context of the examples described herein it is useful to consider the relative vertical and/or horizontal (or lateral) locations of the conductive elements. Thus, the first conductive element is provided in a first substantially horizontal plane and the second conductive element is provided in a second substantially horizontal plane that is spaced from the first horizontal plane. The first and second conductive elements are arranged to at least partially overlap. Thus, the mutually overlapping regions of the first and second conductive elements define first and second electrodes of a capacitor.

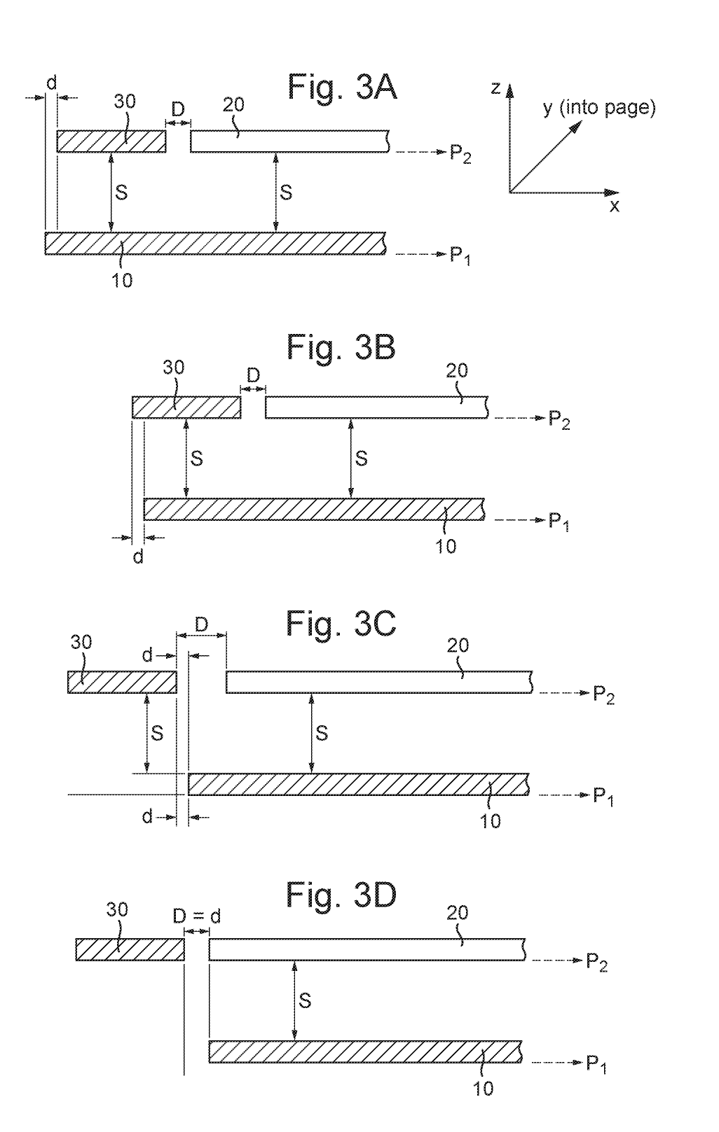

With reference to the examples illustrated in FIGS. 3A to 3D, it will be appreciated that according to one or more examples the second conductive element is spaced from the first conductive element in a separation direction S and that the first and second conductive elements are arranged so as to be mutually overlapping. Thus the second conductive element 20 at least partially overlaps the first conductive element 10 when viewed in a direction normal/vertical to one of the first or second conductive elements.

Example embodiments of MEMS transducers described herein also comprise a third conductive element 30. The third conductive element 30 is provided relative to the second conductive element 20 in a fringing field region of the capacitor that is formed between the first and second conductive elements. The third conductive element can be considered to be a field modifier for modifying an electric field arising between the first and second conductive elements. Thus, the third conductive element may be arranged and configured to modify the electric field, in particular the fringing electric field, that would otherwise arise between the first and second conductive elements. In particular, the third conductive element may be provided in a plane that is spaced from the plane of the first conductive element in the separation direction. Furthermore, the third conductive element may be configured in use to be at a potential differing from the potential of the first conductive element. Thus, the third conductive element is preferably arranged and configured to form a second capacitor with the second conductive element.

In use, one of the electrodes of the capacitor is fixed whilst the other is arranged to be displaced out of the substantially horizontal plane in response to e.g. an incident acoustic pressure wave. The change in distance between the electrode plates is measurable. Thus, example MEMS transducers rely on a capacitive sensing mechanism wherein the distance between first and second electrodes is altered in response to an acoustic pressure differential, giving rise to a detectable change in capacitance between the two electrodes. According to one arrangement, a fixed electrode (which is typically supported by a rigid support structure of the transducer such as a backplate) is biased (e.g. at 12V) whilst a movable electrode that is supported by a flexible membrane of the transducer is held at ground.

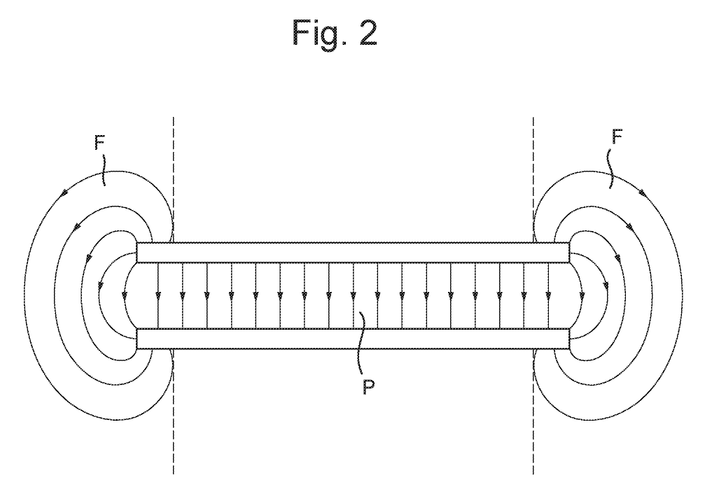

FIG. 2 illustrates the electric field arising between the first and second electrodes of a parallel plate capacitor. As one skilled in the art will appreciate, and as illustrated in FIG. 2, a parallel plate capacitor which is charged/biased gives rise to an electrostatic field component P running from one plate to the other in a direction perpendicular to the plates. In addition, the edge of the plates effectively define a charge distribution boundary of the capacitor from which the electric field will extend or bow laterally. This region may be considered to be a fringing field region F of the capacitor.

The presence of fringing fields is thought to be a significant contributor to the occurrence of sensitivity drift. With reference to FIG. 2, it will be appreciated that fringing fields in combination with moisture present on the exposed surface will cause surface charges to migrate across the surface of the plates and other surfaces in the vicinity of the plates. Thus, surface charges build up, especially in the vicinity of the edges of the first capacitor or the transducer, thereby gradually increasing the charge in the device and the attraction between the plates. It will therefore be appreciated that the surface charges may contribute dynamically to the overall capacitance—and thus the sensitivity—of the transducer.

According to examples described herein, the extent of the fringing field region, and thus the preferred proximity of the third conductive element to the second conductive element, depends on a number of factors including the material used for the conductive elements, the separation distance S between the first and second electrodes and the potential difference between them. However, it is envisaged that the distance between the second and third conductive elements is between 2 μm and 100 μm, preferably between 2 μm and 50 μm and more preferably between 2 μm and 12 μm.

FIGS. 3A to 3D each illustrate a partial, cross-sectional view of a plurality of conductive elements according to examples of the present embodiments. Thus, FIGS. 3A to 3D show the first, second and third conductive elements in the vicinity of one end of the capacitor formed by the first and second conductive elements, and illustrate the relative arrangement of the conductive elements in two mutually orthogonal axes which may conveniently be considered to be the z-axis and the x-axis.

Specifically, a first conductive element 10 provided in a first horizontal plane P1 forms a capacitor with a second conductive element 20 provided in a second horizontal plane P2. Thus the second conductive element is vertically spaced from the first conductive element 10 at a distance S in a separation direction z.

In each of the examples shown in FIGS. 3A to 3D a third conductive element 30 is provided relative to the second conductive element and in substantially the same horizontal plane as the second conductive element 20. Thus, the third conductive element and the second conductive element—which may be formed from a layer of conductive material such as metal—may be conveniently deposited during a single fabrication step. The vertical distance S between the first conductive element and the third conductive element is substantially the same as the vertical distance between the first conductive element and the second conductive element. The third conductive element 30 is horizontally spaced from the second conductive element at a distance D in a horizontal separation direction x.

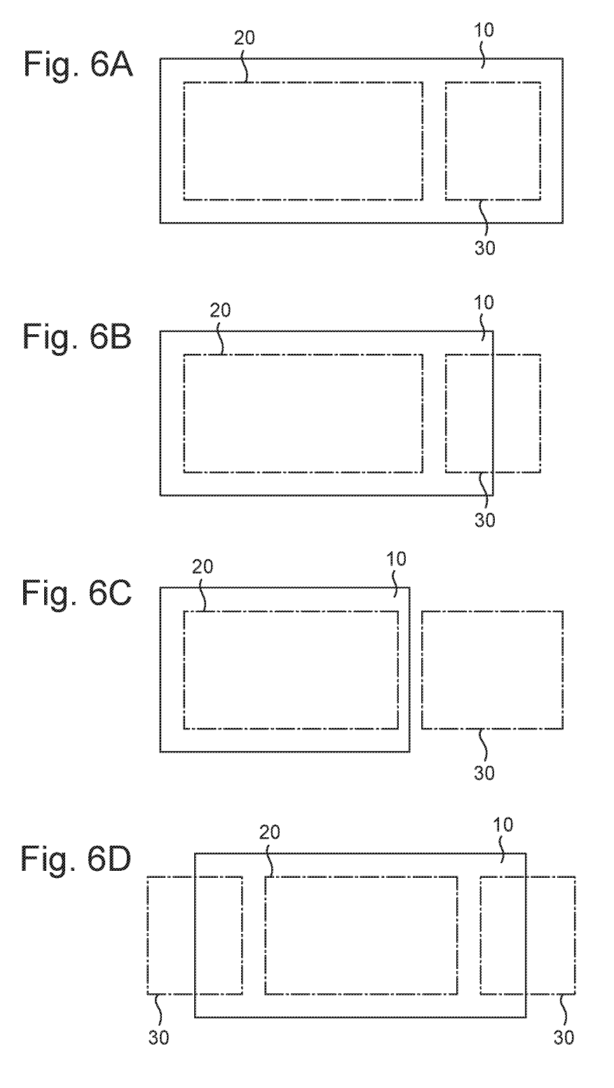

In FIG. 3A the third conductive element 30 is provided so as to fully overlap the first conductive element 10. Thus, if the third conductive element 30 were visualised as a projection onto the plane of the first conductive element from a direction normal to third conductive element, then the entirety of the third conductive element would coincide with the first conductive element. This is similar to the example illustrated in FIG. 6A which illustrates a plan view of a first conductive element 10 wherein the projected positions of the second conductive element 20 and the third conductive element are illustrated by dotted lines in order that the relative lateral (x-axis and y-axis) positions of the conductive elements can be visualised in a single plane.

In FIG. 3B the third conductive element 30 partially overlaps the first electrode 10. Thus, if the third conductive element 30 were visualised as a projection onto the plane of the first conductive element from a direction normal to third conductive element, then a portion of the third conductive element would coincide with the first conductive element, whilst a portion of the third conductive element would extend laterally (i.e. in the x-direction) beyond the boundary of the first electrode. This is similar to the example illustrated in FIG. 6B which again illustrates a plan view of a first conductive element 10 wherein the projected positions of the second conductive element 20 and the third conductive element are illustrated by dotted lines.

In FIG. 3C the third conductive element 30 does not overlap the first conductive element 10. Thus, if the third conductive element 30 were visualised as a projection onto the plane of the first conductive element from a direction normal to third conductive element, then the entirety of the third conductive element 30 will be outside the boundary of the first conductive element 10. This is similar to the example illustrated in FIG. 6C. As illustrated in FIG. 3C, the third conductive element 30 is separated from the second conductive element by a distance D in a horizontal separation direction x. Furthermore, the third conductive element can be considered to be horizontally separated from the first conductive element by a distance d.

Depending on the particular transducer design, it will be appreciated that the first and second conductive elements which form the first and second electrodes of the capacitor may be substantially the same size or, as illustrated in FIGS. 3A to 3C they may be different in size.

FIG. 3D illustrates an example in which the first and second conductive elements are substantially the same size and are arranged so as to be fully overlapping. Thus, if the second conductive element 20 were visualised as a projection onto the plane of the first conductive element, then the first and second conductive elements would fully coincide. In FIG. 3D the third conductive element 30 is again provided outside the boundary of the first conductive element when visualised as a projection onto the plane of the first conductive element. The third conductive element 30 is separated from the second conductive element by a distance D in a horizontal separation direction x. Furthermore, the third conductive element can be considered to be horizontally separated from the first conductive element by a distance d. In this example D=d.

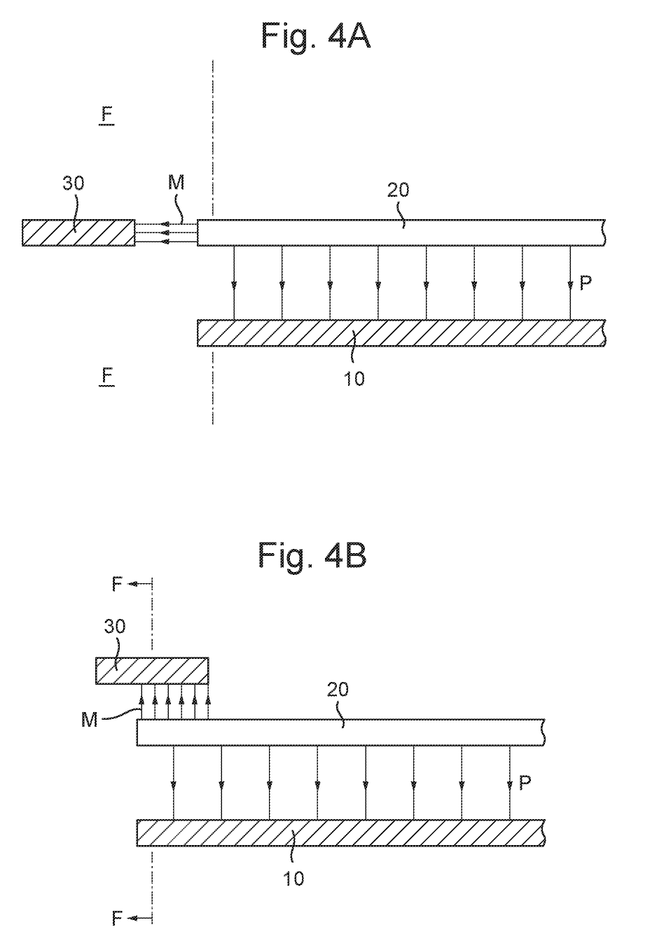

The examples shown in FIGS. 4A and 4B illustrate the effect of the third conductive element on the electric fields, in particular the electric fringing fields, arising between the first and second conductive elements which form first and second electrodes of a capacitor. Specifically, FIG. 4A shows a partial cross-sectional view to illustrate the relative arrangement of the first second and third conductive elements in the proximity of one edge of the capacitor formed by the first and second conductive elements. The relative arrangement of the conductive elements is similar to the arrangement illustrated in FIG. 3D. A parallel electrostatic field P runs between the first conductive element 10 and the second conductive element 20. It will be readily appreciated that the direction of this field will depend on the relative potentials (i.e. the potential difference) of the first and second conductive elements. For example, in some arrangements the first electrode may be biased at a specific voltage (e.g. 12V) whilst the second electrode may be held at ground, or visa versa. According to either arrangement, the third conductive element 30 is preferably configured to be at a different voltage to the second conductive element. Thus, a potential difference will arise between the second and third conductive elements such that a capacity is formed therebetween. According to preferred embodiments the third conductive element 30 is configured to be at substantially the same voltage as the first electrode 10.

As shown in FIG. 4A, in addition to the capacitor that arises between the first and second electrodes, which gives rise to an electric field that may be illustrated by a plurality of parallel electric field lines which extend in a substantially vertical direction (i.e. perpendicular to the plane of the first and second electrodes), and due to a potential difference arising between the second and third conductive elements, a second parallel electric field M (in this example, a horizontal electric field) arises between the edge of the second conductive element 20 and the adjacent edge of the third conductive element 30. Thus, a second capacitor is formed between the second and third conductive elements.

Moreover, according to examples wherein the third conductive element is provided at substantially the same potential as the first conductive element, substantially no electric field arises between the first and third conductive elements. Thus, in effect, by providing the third conductive element in a fringing field region F of the capacitor—i.e. a region where a fringing or non-parallel electric field will arise between the first and second conductive elements in the absence of the third conductive element, the third conductive element can be seen to modify the electric field that would otherwise arise in this region. This is achieved, according to one or more examples, by the formation of a capacitor between the second and the third conductive elements.

According to examples described herein the third conductive element advantageously serves to reduce or even eliminate a fringing electric field arising between the first and second conductive elements. Thus, the third conductive element can be considered to be a field modifier.

Surprisingly, examples described herein which provide a MEMS transducer comprising a third conductive element or field modifier have been shown to demonstrate a significant improvement in the time-dependent sensitivity drift of the transducer. Thus, MEMS transducers according to the present example embodiments benefit from a more stable performance and, potentially, an improved utilisation in applications which require, or would benefit from, enhanced levels of performance stability. The precise mechanism or phenomenon that causes the demonstrated improvement in stability is still unclear. However, it is hypothesised that as a consequence of the reduction in the fringing electric field arising between the first and second electrodes, the migration of surface charges in the vicinity of the edges of the capacitor formed by the first and second conductive elements is inhibited. As a consequence, the migration of surface charges is advantageously restricted and the degree of gradual increase, or drift, in the electrostatic potential is advantageously reduced.

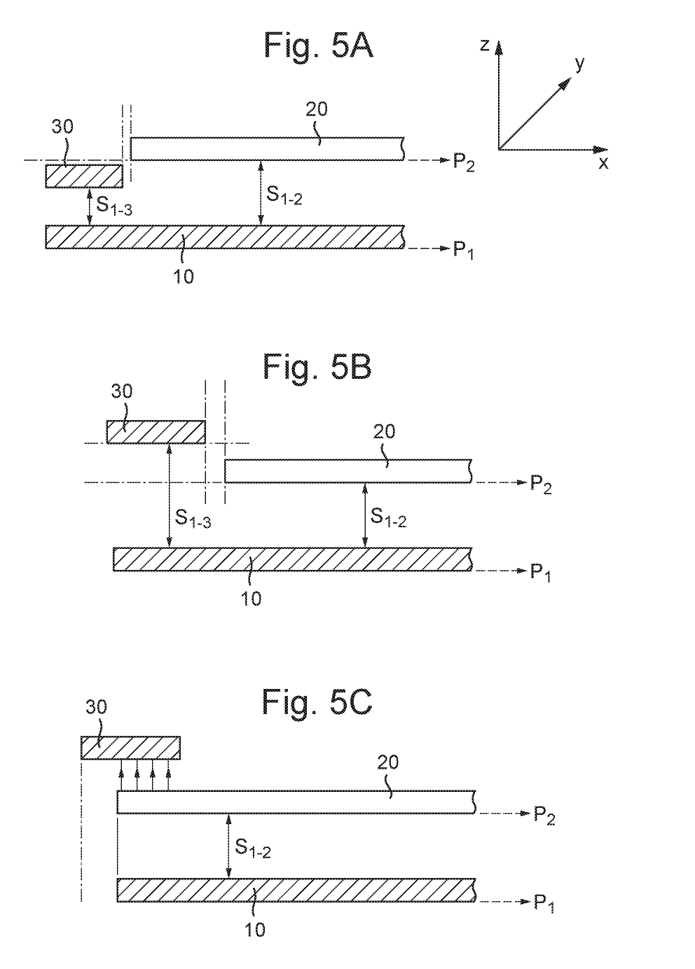

FIGS. 5A to 5C each illustrate partial cross-sectional views to show the relative arrangement between a plurality of conductive elements which may form a MEMS transducer according to examples of the present embodiments. Specifically, a first conductive element 10 provided in a first horizontal plane P1 forms a capacitor with a second conductive element 20 provided in a second horizontal plane P2. Thus the second conductive element is vertically spaced from the first conductive element 10 at a distance S₁₋₂ in a separation direction z.

In each of the examples shown in FIGS. 5A to 5C a third conductive element 30 is provided in a fringing field region of the capacitor defined by the first and second conductive elements. The third conductive element 30 is spaced from the first conductive element 10 in the separation direction z. In FIG. 5A the third conductive element is provided in a plane between the plane of the first conductive element P1 and the plane of the second conductive element P2. In FIG. 5B the third conductive element is provide in a plane above the plane of the second conductive element. In both FIGS. 5A and 5B the third conductive element fully overlaps the first conductive element.

Thus, FIGS. 5A and 5B illustrate a number of different planar positions of the third conductive element. Specifically, the third conductive element is not provided in the same plane as the second conductive element but is nonetheless spaced from the first conducive element at a distance S₁₋₃ in the separation direction z.

It will be appreciated that numerous different arrangements are envisaged within the context of the present embodiments, in addition to those specifically illustrated herein, by varying the relative horizontal and/or vertical positions of the three conductive elements and/or by varying the size and/or shape of the conductive elements. Preferably, however, the third conducive element is located so as to form a capacitor with the second conductive element and thus act as a field modifier for modifying the electric arising in a fringing field region of the capacitor. Thus, the third conductive element may be located in a region adjacent to the second conductive element. In particular, the third conductive element may be spaced from the first conductive element in the separation direction. The third conductive element may be provide in the same plane as the second conducive element, in a plane between the first and second conducive elements or in a plane above the second conductive element. Thus, the third conductive element may be provided within a fringing field region of the capacitor defined by the first and second conducive elements—i.e at least a part of the third conductive element extends into the fringing field region. The third conductive element may preferably be configured to be at substantially the same voltage as the first conductive element. This may be beneficially achieved by a direct physical and electrical connection between the first conductive element and the third conductive element. For example, one or more conductive tracks or columns may be provided which extend between the plane of the first conductive element and the plane of the third conductive element. This is a simple and readily implemented way of configuring the third electrode to be at the same potential as the first conductive electrode.

A further example is illustrated in FIG. 5C in which the third conductive element is provided in a plane above the second conductive element and also partially overlaps the second conductive electrode. Furthermore, in contrast to the arrangements shown in FIGS. 5A and 5B the boundary of the first and the second conductive elements that is illustrated by the partial cross section (i.e. at one end of the capacitor) substantially coincides.

FIG. 4B illustrates the field lines associated with the arrangement illustrated in FIG. 5C. A parallel electrostatic field P runs between the first conductive element 10 and the second conductive element 20. In addition to the parallel electric field lines which extend in a substantially vertical direction (i.e. perpendicular to the plane of the first and second electrodes), and due to a potential difference arising between the second and third conductive elements, a capacitor is formed between the mutually overlapping portions of the second conductive element 20 and the third conductive element 30 which is illustrated by the electric field lines M.

Moreover, according to examples in which the third conductive element 30 is at or near the same potential as the first conductive element, substantially no electric field arises between the first and third conductive elements. The provision of the third conductive element 30 in the fringing field region F of the capacitor thus serves to modify the electric field arising in this region when compared to the electric field that would arise in the absence of the third conductive element and just in the vicinity of the first and second conductive elements.

It will be appreciated that the fringing field region will extend all the way around the capacitor defined by the first and second conducive elements. Thus, according to one or more examples it may be desirable for the third conductive element to be provided so as to define a region of conductive material, within the fringing field region, which extends in a region outside the boundary of the first capacitor. Thus, the third conductive element may advantageously define a closed loop of conductive material. The shape of the loop may depend on the shape of the first and second electrodes which may be e.g. square/rectangular or circular. Thus, the shape may substantially correspond to the shape of the first and second electrodes. In the case of a capacitor formed of circular planar electrodes, the third conductive element may for example take the form of an annulus. Alternatively, the third conductive element may comprise a plurality of discrete sub-elements of conductive material arranged at intervals around the fringing field region. Preferably, the sub-elements will be configured to be at substantially the same voltage.

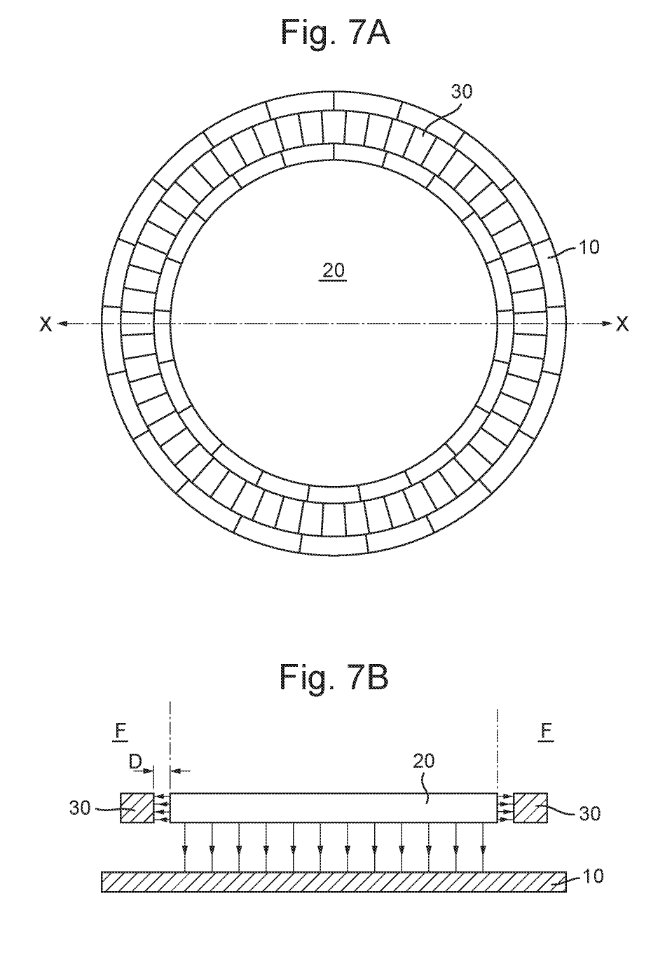

FIGS. 7A and 7B illustrate first, second and third conductive elements of a MEMS transducer. Specifically, FIG. 7A illustrates a plan view of the conductive elements from above whilst FIG. 7B shows a cross sectional view through the line X-X shown in FIG. 7A. The first and second conductive elements are both circular in shape and define a parallel plate capacitor in the region where they overlap. Thus, a fringing field region laterally surrounds the region of the capacitor. The third conducive element forms a complete ring of conductive material and is provided in the same plane as the second conductive element. In this example, the third conductive element 30 is provided so as to fully overlap the first conductive element and is spaced at a horizontal distance D from the second conductive element 20.

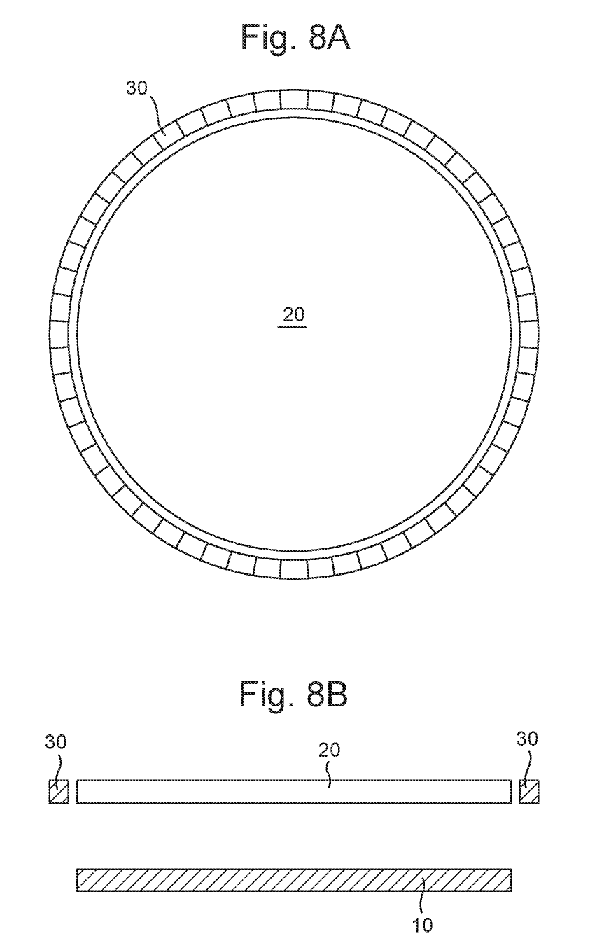

FIGS. 8A and 8B illustrate first, second and third conductive elements of further example embodiment of a MEMS transducer. Specifically, FIG. 8A illustrates a plan view of the conductive elements from above whilst FIG. 8B shows a cross sectional view through the line X-X shown in FIG. 8A. The first and second conductive elements are both circular in shape and define a parallel plate capacitor in the region where they overlap. Thus, a fringing field region laterally surrounds the region of the capacitor. The third conducive element 30 forms a complete ring of conductive material and is provided in the same plane as the second conductive element. In this example, the first 10 and second 20 conductive elements are the same size and are arranged so as to fully overlap. The third conductive element 30 is provided in a region outside the first capacitor formed by the first and second conductive elements at a horizontal distance D=d from both the first 10 and second 20 conductive elements. The third conductive element 30 is configured to be at a potential differing from the potential of the second conductive element 20, preferably at the same potential as the first conductive element 10. Thus, the second 20 and third 30 conductive elements form a second capacitor.

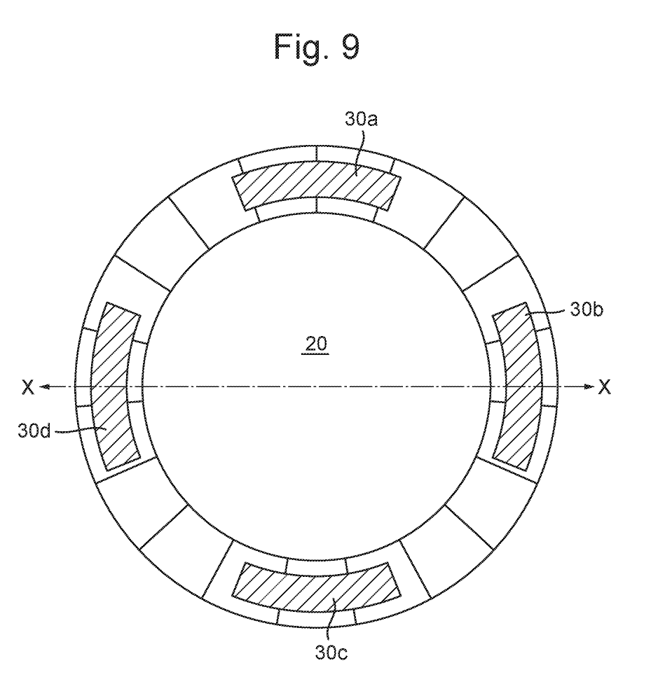

FIG. 9 illustrates a plan view of first, second and third conductive elements of further example embodiment of a MEMS transducer. In this example the third conductive element 30 comprises a plurality of discrete sub-elements 30a, 30b, 30c and 30d of conductive material. These may be beneficially arranged at regular intervals around the fringing field region as shown, or may be arranged in an irregular fashion. Preferably, the discrete sub-elements will be configured to be at substantially the same voltage as one another. Preferably, each of the discrete sub-elements which form the third conductive element are configured to be at a potential differing from the potential of the second conductive element 20. More preferably, each of the discrete sub elements is configured to be at the same potential as the first conductive element 10. Thus, in this example four additional capacitors are formed, one between each of the sub-elements of the third conductive element 30 and the second conductive element.

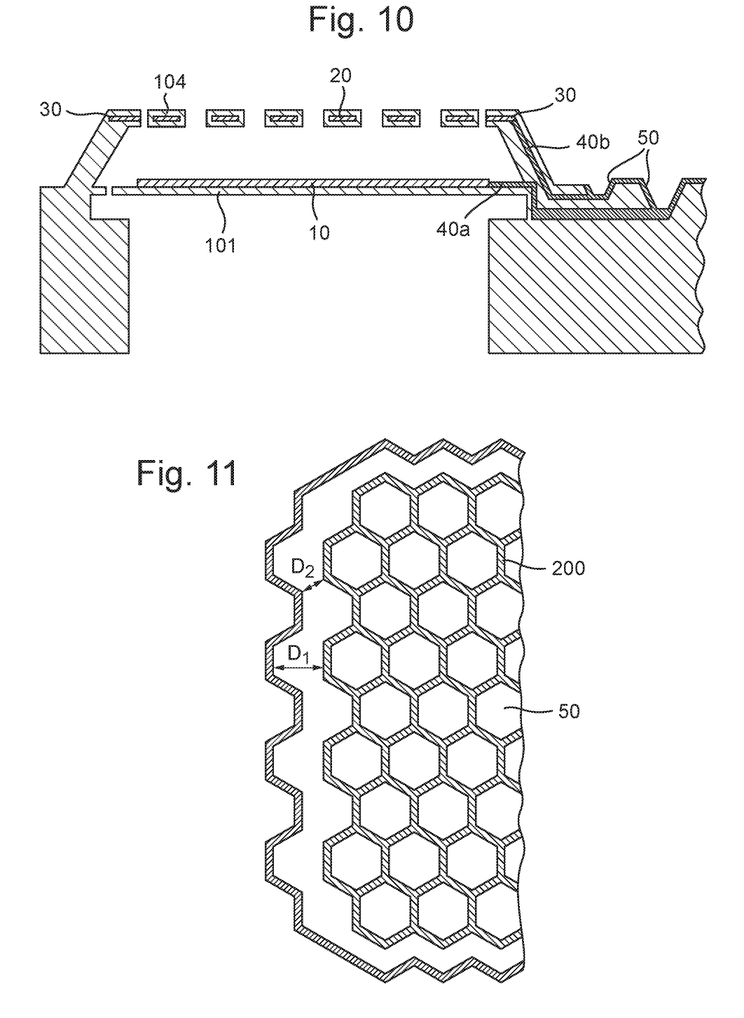

According to one or more examples, there is provided a MEMS transducer wherein the first conductive element is supported by a flexible membrane of the MEMS transducer and the second conductive element is supported by a fixed support structure—such as a backplate—of the MEMS transducer. In this arrangement it may be convenient for the third conductive element to be supported by the fixed support structure. For example, the third conductive element may be supported on or within the side walls of the transducer—e.g. in a plane between the membrane and backplate electrodes. Alternatively, and according to a preferred example, the third conductive element may be embedded within the back plate structure, or may be mounted to the upper or lower surfaces of the back plate structure. Such an arrangement is shown in FIG. 10 which illustrates the third electrode 30 embedded within the backplate structure 104 of a MEMS transducer, laterally outside the region of the capacitor formed by the membrane electrode 10 and the backplate electrode 20.

Alternatively, according to one or more examples, a MEMS transducer is provided in which the first conductive element is supported by the back plate structure of the transducer and the second conductive element is supported by the flexible membrane of the MEMS transducer. In this arrangement is may be convenient for the third electrode is supported by the flexible membrane or by the side walls of the transducer—e.g. in a plane between the membrane and backplate electrodes.

There are a number of ways in which the third electrode may be configured to be at substantially the same voltage as the first electrode.

According to one or more examples, and with reference to FIG. 10, a conductive path 40 directly connects the third conductive element 30 with the first conductive element 10. This may be achieved by means of e.g. one or more vias and/or a conductive or metal track which extends between the planes of the first and third conductive elements. In the example illustrated in FIG. 10 a first conductive track 40a extends from an edge of the first conductive element 10 into a sidewall of the transducer and make contact with a metal via 50. Furthermore, a second conductive track 40b extends from the third conductive element into a sidewall of the transducer and also makes contact with the metal via 50. In this way, a direct conductive path is provided between the third conductive element and the first conductive element. This arrangement provides a simple way to configure the third electrode so as to be at a potential that is the same as the potential of the first electrode. Furthermore, according to embodiments of the present invention in which the first and second conductive elements are supported by one or more layers of dieletric material, for example one of the first and second conductive elements may be supported by a membrane formed of a dieletric material such as silicon nitride, and the other of first and second conductive elements may be supported by a dieletric material which forms a rigid support structure or backplate of the transducer, the fabrication of the transducer will involve the deposition of several conductive layers to form the second and third conductive elements. Thus, the additional deposition of conductive metal to form the third conductive element, as well as a conductive path between the first and third conductive elements, requires only a minor modification to the established fabrication process.

Alternatively, embodiments are envisaged in which a circuit is provided which allows the potential of the third conductive element to be set to be at a potential that differs from the second conductive element, and is preferably set at or near the same potential as the first conductive element. According to one or more example, a bias voltage is applied to the third conductive element which is substantially equal to a bias voltage applied to the first electrode. According to other examples, the first conductive element and the third conductive element are configured to be at ground potential.

Examples are also envisaged in which the first conductive element also forms a membrane or back plate of the transducer. Thus, rather than the membrane and/or backplate being formed of a dielectric material, they may be formed of an electrically conductive material such that a first capacitor of the transducer is established between them.

A transducer according to examples of the present embodiments will preferably be provided with a rigid support structure, such as a backplate. Thus, the backplate may support either the first conductive element or the second and third conductive elements. Such backplate structures are typically provided with acoustic holes to allow free movement of air molecules through the backplate. Thus, it will be appreciated that any of the examples described herein may be arranged such that the first conductive element is provided on a flexible membrane of the transducer whilst the second conductive element is supported by (either formed on or embedded within) a rigid support structure such as a back plate. Alternatively, the first conductive element may be supported by the backplate whilst the second conductive element is formed on the flexible membrane. In either case, the third conductive element is spaced from the first conductive element in the separation direction whilst being held at or close to the same potential as the first conductive element. Thus, the third conductive element may be conveniently supported by either the membrane or the backplate structure.

Depending on the precise manner of fabrication, it may be convenient for the third conductive element to be deposited during the deposition of conductive material that forms either the membrane electrode or the backplate electrode. The conductive material may be metal, such as aluminium, or a metal-alloy such as aluminium-silicon alloy or titanium nitride. Alternatively the conductive material may be a conductive dielectric material, such as include titanium nitride, polysilicon, silicon carbide, amorphous silicon, tantalum nitride.

It is typical for the backplate structure to comprise a plurality of holes—e.g. acoustic holes 0 which through the back-plate structure. Thus, the backplate electrode—which may be the first or second conductive element within the context of the present invention—will also be patterned to comprise a plurality of holes which correspond to the acoustic holes formed in the backplate. According to previously considered designs the membrane electrode may also be patterned to incorporate a plurality of holes such that at least a part of the area of at least one opening in the membrane electrode corresponds to the area of at least one hole in the backplate electrode. It will be appreciated that the size of the backplate holes may be the same as the size of some of the openings in the membrane electrode, although these need not necessarily be the case.

The holes or openings in the membrane electrode or the backplate electrode may be of any shape, for example circular or polygonal (e.g. square) in shape. In particular, the openings in the membrane electrode may be hexagonal in shape.

FIG. 11 illustrates a part of a second conductive element 200 which comprises a plurality of hexagonal holes. The second conductive element may form a backplate electrode or a membrane electrode of a transducer. A first conductive element (not shown) may, for example, be a patterned electrode having a plurality of openings that are arranged so as to be mutually overlapping with the holes of the second conductive element.

A third conductive element 300 is provided in substantially the same plane as the second conductive element. For example, the third conductive element may be supported by, or embedded within, a backplate structure, in the case where the second conductive element 200 comprises a backplate electrode of the first capacitor. Alternatively, the third conducive element 300 may be supported by a layer of membrane material in the case where the second conductive element comprises a membrane electrode of the first capacitor. It will be appreciated that the third conductive element substantially follows the outline of the hexagonal lattice structure of the second conductive element.

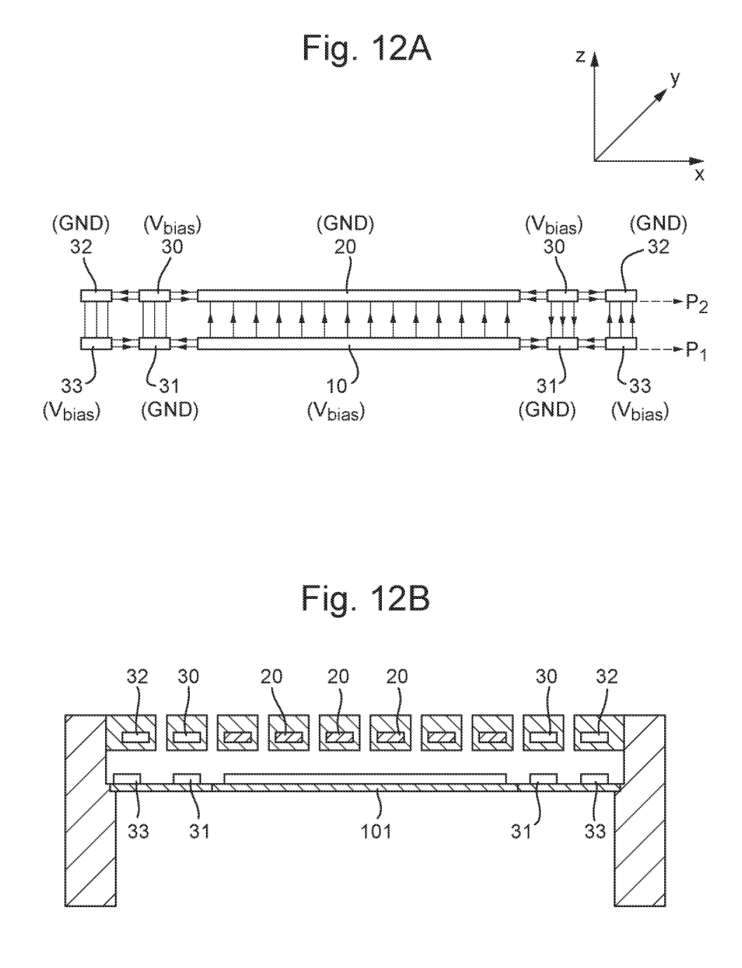

FIGS. 12A and 12B illustrate further example embodiments. Specifically, FIG. 12A illustrates a cross-sectional view to show the relative arrangement between a plurality of conductive elements which may comprise part of MEMS transducer. Specifically, a first conductive element 10 provided in a first horizontal plane P1 forms a first capacitor with a second conductive element 20 provided in a second horizontal plane P2. Thus the second conductive element 20 is vertically spaced from the first conductive element 10 in a separation direction z.

As in previous examples, a third conductive element 30 is provided in a fringing field region of the first capacitor defined by the first and second conductive elements. As shown, the third conductive element 30 is also spaced from the first conductive element 10 in the separation direction z. In the illustrated example the third conductive element 30 is provided in substantially the same horizontal plane P2 as the second conductive element, although this is not essential, and may be conveniently be supported by a backplate structure of the transducer as shown in FIG. 12B.

The example illustrated in FIG. 12A further comprises a fourth conductive element 31, which is also provided in the fringing field region of the first capacitor. The fourth conductive element 31 is provided in the first horizontal plane P1, although this is not essential, and may be conveniently supported by a membrane of the transducer as shown in FIG. 12B. Thus, the third conductive element is separated from the fourth conductive element in the z direction. The third and fourth conductive elements can be considered to form a first pair of conductive elements.

The example also comprises fifth and sixth conductive elements which are provided laterally outside the first quad pair of conductive elements. The fifth conductive element is provided in substantially the same horizontal plane P2 as the second conductive element, although this is not essential, and may be conveniently be supported by a backplate structure of the transducer as shown in FIG. 12B. The sixth conductive element is provided in the first horizontal plane P1, although this is not essential, and may be conveniently supported by a membrane of the transducer as shown in FIG. 12B. The fifth and sixth conductive elements can be considered to form a second pair of conductive elements.

The first and second quad pairs of conducive elements can be considered to form a quad arrangement of conductive elements.

According to preferred embodiments the third conductive element 30 is configured to be at a different voltage to the second conductive element. According to a preferred arrangement the third conductive element 30 is configured to be at substantially the same voltage as the first electrode 10. Furthermore, the fourth conductive element 31 is configured to be at substantially the same voltage as the second conductive element 20. Thus, the third and fourth conducive elements which form the first pair are at different potentials. Furthermore, at least a portion of the third and fourth conductive elements are mutually overlapping thereby defining a parallel electrostatic field therebetween.

Preferably, the fifth conductive element 32 is configured to be at a different voltage from the third conductive element 30. According to a preferred arrangement the fifth conductive element 32 is at substantially the same voltage as the fourth conductive element 31 and the second conductive element 20. Preferably also the sixth conductive element 33 is configured to be at a different voltage from the fourth conductive element 31. Furthermore, according to a preferred arrangement the sixth conductive element is at substantially the same voltage as the first and third conductive elements.

According to a preferred arrangement based on the FIG. 12A example, the first, fourth and sixth conductive elements are configured, in an operational mode, to be at a first potential whilst the second, third and fifth conductive elements are configured to be at a second potential that is different to the first potential. Thus, the first, fourth and sixth conductive elements may be configured to be at a bias potential whilst the second, third and fifth conductive elements may be configured to be held at a ground potential, or visa versa.

FIG. 12B illustrates a particular implementation in which the first conductive elements are provided on an upper surface of the transducer membrane 101 whilst the fourth and sixth conductive elements are provided laterally outside the first conductive element in the same plane thereof. Thus, the fourth and sixth conductive elements may be supported by a substrate portion of the transducer or by a region of the membrane. Furthermore, the second, third and fifth conductive elements are supported by a backplate structure 104 of the transducer.

Each of the third to sixth conductive elements may comprise a loop of conductive material. Thus, the membrane electrode can be considered to be surrounded by two concentric loops of conductive material. Similarly the backplate electrode.

It will be appreciated that due to potential differences that arise between the various conductive elements, a plurality of capacitors are defined by the arrangement shown in FIG. 12A, in addition to the first capacitor defined between the first and second conductive elements. It will be appreciated that a potential difference arises between a number of the conductive elements in the same plane.

Specifically, within the plane P2, parallel electrostatic fields are set up in the horizontal direction between the adjacent edges of the second and third conductive elements and also between the adjacent edges of the third and fifth conductive elements.

Furthermore, within the plane P1, parallel electrostatic fields are set up in the horizontal direction between the adjacent edges of the first and fourth conductive elements and also between the adjacent edges of the fourth and sixth conductive elements.

The horizontal electrostatic fields are established in a fringing field region of the vertical capacitances that are established in use in the vertical (z) direction between the conductive elements in the first plane and the conductive elements in the second plane. The horizontal electric fields serve to modify an electric field that would otherwise arise, in particular by reducing the occurrence of any fringing electric fields in the vicinity of the vertical capacitances of the structure.

The so-called “quad” arrangement of conductive elements that is illustrated in FIGS. 12A and 12B may be implemented using two metal layers within the transducer structure, namely the membrane metal layer (that forms the membrane electrode of first conductive element) and the backplate metal layer (that forms the backplate electrode of second conductive element).

The arrangement illustrated in FIGS. 12A and 12B may be advantageous in that electric field lines originating from the inner quad pair will be captured by the outer conductive element(s).

The flexible membrane may comprise a crystalline or polycrystalline material, such as one or more layers of silicon-nitride Si₃N₄.

MEMS transducers according to the present examples will typically be associated with circuitry for processing an electrical signal generated as a result of detected movement of the flexible membrane, either by a capacitive sensing technique or by an optical sensing technique. Thus, in order to process an electrical output signal from the microphone, the transducer die/device may have circuit regions that are integrally fabricated using standard CMOS processes on the transducer substrate.

The circuit regions may be fabricated in the CMOS silicon substrate using standard processing techniques such as ion implantation, photomasking, metal deposition and etching. The circuit regions may comprise any circuit operable to interface with a MEMS transducer and process associated signals. For example, one circuit region may be a pre-amplifier connected so as to amplify an output signal from the transducer. In addition another circuit region may be a charge-pump that is used to generate a bias, for example 12 volts, across the two electrodes. This has the effect that changes in the electrode separation (i.e. the capacitive plates of the microphone) change the MEMS microphone capacitance; assuming constant charge, the voltage across the electrodes is correspondingly changed. A pre-amplifier, preferably having high impedance, is used to detect such a change in voltage.

The circuit regions may optionally comprise an analogue-to-digital converter (ADC) to convert the output signal of the microphone or an output signal of the pre-amplifier into a corresponding digital signal, and optionally a digital signal processor to process or part-process such a digital signal. Furthermore, the circuit regions may also comprise a digital-to-analogue converter (DAC) and/or a transmitter/receiver suitable for wireless communication. However, it will be appreciated by one skilled in the art that many other circuit arrangements operable to interface with a MEMS transducer signal and/or associated signals, may be envisaged.

It will also be appreciated that, alternatively, the microphone device may be a hybrid device (for example whereby the electronic circuitry is totally located on a separate integrated circuit, or whereby the electronic circuitry is partly located on the same device as the microphone and partly located on a separate integrated circuit) or a monolithic device (for example whereby the electronic circuitry is fully integrated within the same integrated circuit as the microphone).

Examples described herein may be usefully implemented in a range of different material systems, however the examples described herein are particularly advantageous for MEMS transducers having membrane layers comprising silicon nitride.

One or more MEMS transducers according to the examples described here may be located within a package. This package may have one or more sound ports. A MEMS transducer according to the examples described here may be located within a package together with a separate integrated circuit comprising readout circuitry which may comprise analogue and/or digital circuitry such as a low-noise amplifier, voltage reference and charge pump for providing higher-voltage bias, analogue-to-digital conversion or output digital interface or more complex analogue or digital signal processing.

A MEMS transducer according to the examples described here may be located within a package having a sound port.

It is noted that the example embodiments described above may be used in a range of devices, including, but not limited to: analogue microphones, digital microphones, pressure sensor or ultrasonic transducers. The example embodiments may also be used in a number of applications, including, but not limited to, consumer applications, medical applications, industrial applications and automotive applications. For example, typical consumer applications include portable audio players, laptops, mobile phones, PDAs and personal computers. Example embodiments may also be used in voice activated or voice controlled devices. Typical medical applications include hearing aids. Typical industrial applications include active noise cancellation. Typical automotive applications include hands-free sets, acoustic crash sensors and active noise cancellation.

Features of any given aspect or example embodiment may be combined with the features of any other aspect or example embodiment and the various features described herein may be implemented in any combination in a given embodiment.

Associated methods of fabricating a MEMS transducer are provided for each of the example embodiments.

It should be understood that the various relative terms above, below, upper, lower, top, bottom, underside, overlying, underlying, beneath, etc. that are used in the present description should not be in any way construed as limiting to any particular orientation of the transducer during any fabrication step and/or it orientation in any package, or indeed the orientation of the package in any apparatus. Thus the relative terms shall be construed accordingly.

In the examples described above it is noted that references to a transducer may comprise various forms of transducer element. For example, a transducer may be typically mounted on a die and may comprise a single membrane and back-plate combination. In another example a transducer die comprises a plurality of individual transducers, for example multiple membrane/back-plate combinations. The individual transducers of a transducer element may be similar, or configured differently such that they respond to acoustic signals differently, e.g. the elements may have different sensitivities. A transducer element may also comprise different individual transducers positioned to receive acoustic signals from different acoustic channels.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference signs in the claims shall not be construed so as to limit their scope.

1. A MEMS transducer comprising first and second conductive elements, the second conductive element being provided in a plane which overlies a plane of the first conductive element, wherein a mutually overlapping region of the first and second conductive elements defines a first capacitor of the transducer,
the transducer further comprising a third conductive element, wherein the third conductive element is provided in a plane that overlies the plane of the first conductive element and wherein the third conductive element is configured to be at a potential different to the potential of the second conductive element.

2. A MEMS transducer as claimed in claim 1, wherein the third conductive element is configured to be at substantially the same potential as the potential of the first conductive element.

3. (canceled)

4. A MEMS transducer as claimed in claim 1, wherein the third conductive element is provided in a fringing field region of the first capacitor.

5.-7. (canceled)

8. A MEMS transducer as claimed in claim 1, wherein the third conductive element at least partially overlies the first conductive element when viewed in a direction normal to the third conductive element.

9. (canceled)

10. A MEMS transducer as claimed in claim 1, wherein the third conductive element is provided in a region which, when projected onto the plane of the first electrode, is laterally outside the region of the first conductive element.

11. A MEMS transducer as claimed in claim 1, wherein the third conductive element comprises a plurality of sub-elements, each of the element portions being configured to be at substantially the same voltage.

12. A MEMS transducer as claimed in 1, wherein the third electrode forms a closed loop.

13. A MEMS transducer as claimed in claim 1, wherein the third conductive element is provided at one of:
a) a plane between the plane of the first conductive element and the plane of the second conductive element;
b) the same plane as the second conductive element; and
c) a plane above the plane of the second conductive element.

14.-15. (canceled)

16. A MEMS transducer as claimed in claim 1, wherein the first conductive element is supported by a flexible membrane of the MEMS transducer and the second electrode is supported by a fixed support structure of the MEMS transducer.

17. A MEMS transducer as claimed in claim 16, wherein the third conductive element is supported by the fixed support structure.

18. A MEMS transducer as claimed in claim 1, wherein the first conductive element is supported by a fixed support structure of the MEMS transducer and the second conductive element is supported by a flexible membrane of the MEMS transducer.

19. A MEMS transducer as claimed in claim 18, wherein the third conductive element is supported by the flexible membrane.

20.-21. (canceled)

22. A MEMS transducer as claimed in claim 1, wherein the second conductive element comprises a hexagonal lattice structure and wherein the third conducive element follows a path which substantially follows or corresponds to the outer edge of the hexagonal lattice structure.

23. A MEMS transducer as claimed in claim 1, further comprising a fourth conductive element, wherein the third conductive element at least partially overlies the fourth conductive element so as to define a third capacitor.

24. A MEMS transducer as claimed in claim 23, wherein the fourth conductive element is configured to be at a potential different to the third conductive element.

25. A MEMS transducer as claimed in claim 23, further comprising a fifth conductive element and a sixth conductive element, the fifth and sixth conductive elements being provided within a fringing field region of the third capacitor and arranged such that the fifth conductive element at least partial overlies the sixth conductive element so as to define a fourth capacitor.

26. A MEMS transducer as claimed in claim 25, wherein the sixth conductive element is configured to be at a potential different to the fifth conductive element.

27. A MEMS transducer as claimed in claim 25, wherein the first, fourth and sixth conductive elements are configured to be at a first potential whilst the second, third and fifth conductive elements are configured to be at a second potential that is different to the first potential.

28.-29. (canceled)

30. A MEMS transducer as claimed in claim 1, wherein the third conductive element is electrically connected to the first conductive element.

31. A MEMS transducer as claimed in claim 1, wherein a bias voltage is applied to the third conductive element and wherein the bias voltage is substantially equal to a bias voltage applied to the first electrode.

32. (canceled)

33. A MEMS transducer comprising first and second conductive elements of a capacitor, the MEMS transducer further comprising a field modifier provided in a fringing field region of the capacitor, the field modifier located to form a parallel electric field between the second conductive element and the field modifier.

34. A MEMS transducer comprising
a flexible membrane;
a rigid backplate;
a membrane electrode formed on an upper surface of the membrane;
a backplate electrode, formed on or within the backplate;
a third conductive element provided at a potential different to the potential of the membrane electrode and located so as to form a capacitor with the backplate electrode.

35.-46. (canceled)
